(19) United States
(12) Patent Application Publication
(10) Pub. No.: US 2019/0372248 A1
(43) Pub. Date: Dec. 5, 2019

(54) Electrical Connector For Circuit Boards

(71) Applicant: IMS Connector Systems GmbH, Loeffingen (DE)

(72) Inventors: Marius Schaeuble, Albbruck (DE); Roland Baumgaertner, Bonndorf-Wellendingen (DE)

(73) Assignee: IMS Connector Systems GmbH, Loeffingen (DE)

(21) Appl. No.: 16/432,271

(22) Filed: Jun. 5, 2019

(30) Foreign Application Priority Data
Jun. 5, 2018 (DE) 10 2018 113 278.6

(51) Int. Cl. H01R 12/52; H01R 12/70; H01R 13/17; H01R 12/73

(52) U.S. Cl. CPC H01R 12/52; H01R 12/732; H01R 13/17; H01R 12/7082

(57) ABSTRACT

An electrical connector with an outside conductor, that has a sleeve and at least one inner sleeve that is positioned inside the sleeve and extends in the axial direction across a section of the sleeve, with an inner conductor and with a dielectric designed as a cylindrically shaped dielectric body with an internal hole to receive the inner conductor, for which the sleeve is fitted with an axial support section and an axial balance section which are connected across an axial flexure section, for which the flexure section boasts at least one slot running along a perimeter of the sleeve whereby the unslotted area is designed as the support section with the connecting bridge connecting with the balance section and for which the dielectric body boasts a first dielectric sub-body positioned in the support section and a second dielectric sub-body positioned in the connecting section, wherein the first and the second dielectric sub-body are arranged in the sleeve with a space between them, as well as an electrical connector arrangement with one electrical plug connector in accordance with one of the prior claims and a mating connector.

### CROSS-REFERENCE TO RELATED APPLICATIONS

This application claims priority to German Patent Application No. 10 2018 113 278.6, filed Jun. 5, 2018, which is incorporated by reference in its entirety.

### BACKGROUND

The present application relates to an electrical connector for circuit boards as well as a connector arrangement with a connector and an accompanying mating connector. In addition, the present application concerns an application of the connector arrangement for the electrical connection of two circuit boards.

### SUMMARY

For the electrical connection of neighboring and parallel-oriented circuit boards, connectors are used that are attached to facing surfaces of the circuit boards. Such connectors, designated as B2B (board-to-board) connectors, consist of three connector parts, namely two sockets attached to the circuit boards respectively and one adapter (also designated as “bullet”) that is designed on both ends as a plug. With one such adapter, one can not only make up a tolerance compensation with regard to the spacing of the circuit boards that are to be connected, but also the lateral offset with respect to the longitudinal axes of the two sockets. The disadvantage of such B2B connectors is their three-part design.

One possibility for arriving at a simplification of the construction, as is known from EP 2 780 985 B 1, consists of providing a coaxial connecting element whose outside conductor boasts a first conductor with a pipe-shaped mantle whose ends are intended for contact with the two circuit boards and that boasts openings for tolerance compensation with regard to the spacing of the circuit boards, and whose outside conductor also boasts a tube-shaped second conductor in electrical contact with the first conductor that is connected with a section of the first conductor and stands in movable axial contact with a section of the first conductor. However, a lateral offset of the circuit boards that are to be connected can be only poorly compensated with this coaxial connecting element.

The present disclosure is faced with the task of specifying an improved connector of the type stated at the outset with which a B2B plug connection can be produced. A further task consists of specifying a plug connector arrangement for this electrical connector with which a B2B connection can be achieved.

These tasks are being solved by a connector and a connector arrangement having the features and structures recited herein. Further advantageous developments are also disclosed herein.

Such an electrical connector with
a. an outside conductor that boasts a sleeve and at least one inner sleeve that is provided inside the first sleeve and extends in the axial direction across a section of the sleeve,
b. an inside conductor, and
c. a dielectric designed as a cylindrically shaped dielectric body with an internal hole to receive the inside conductor,
distinguishes itself, according to the present disclosure, by virtue of the fact that
a. the sleeve is designed with an axial support section and an axial balance section which are connected across an axial flexure section,
b. the flexure section boasts at least one slot running on a perimeter of the sleeve whereby the unslotted area is designed as the support section with connecting bridge connecting with the balance section, and
c. the dielectric body boasts a first dielectric sub-body positioned in the support section and a second dielectric sub-body positioned in the connecting section, wherein the first and second dielectric sub-bodies are separated from one another in the sleeve.

With such an electrical connector in accordance with the disclosure, which, together with a mating connector, form a B2B plug connection, the tolerance compensation compensating for the lateral offset in the electrical connector is integrated by means of a flexible flexure section of the sleeve. By means of this flexible flexure section, the balance section can be swung with respect to the support section which is preferably connected to a circuit board out of the direction of the longitudinal axis of the sleeve of the connector. This is therefore inapplicable to an adapter known to the prior art in that only two components are necessary for achieving a B2B connection.

In order to make it possible to automate the mounting process as well as the connection of the circuit boards, the two components of the B2B connector in accordance with the disclosure can be implemented as SMD components.

In order to clarify the terminology being used, it is pointed out that a perimeter of a sleeve in the description of the electrical plug connector and/or the sleeve in a cylindrical coordinate system, in which the axis defining the axial direction of the electrical connector is specified, is a line whose points all boast the same coordinates on this axis so that the perimeter lies on a level that is perpendicular to the plug direction.

The construction of the outside conductor with a sleeve and at least one inner sleeve that is positioned inside the sleeve and extends in the axial direction across a section of the sleeve, can thus contribute significantly to an improvement of the signal transmission properties when used for applications in the field of HF technology. It is self-explanatory that in order for the inner sleeve to be a component of the outside conductor, at least some of it must be in electrical contact with the sleeve.

It is especially advantageous in this regard if an inner sleeve is available that extends across the flexure section. In terms of HF technology, the introduction of slots in an outside conductor implemented as a sleeve, as takes place in the flexure section, can lead to a noticeable deterioration of the signal quality. This effect can be countered effectively by an inner sleeve that extends across the flexure section and thereby covers this section.

This form of implementation is further improved by the fact that the inner sleeve springs back radially in the flexure section. In order to assure the desired flexibility of the plug connector in this area, empty volumes remain between the first and the second dielectric sub-bodies, that bring with them undesired effects from the standpoint of HF technology. As a result of the radial springing back of the inner sleeve in this area, this empty volume can be noticeably reduced.

According to a preferred embodiment of the disclosure, the inner sleeve is mechanically connected tight to the support section and is electrically conductive and contacts the connecting section in electrically conducting fashion such that the contact point or the contact surface between inner sleeve and support section on the inside surface of the connecting section is movable. In this fashion, this can contribute to the fact that the quality of the electrical contact caused by mechanical loading of the contact surface during deformations of the balance section hardly changes.

If the inner sleeve is supported on the first dielectric sub-body positioned in the support section and/or is connected to the first dielectric sub-body positioned in the support section, migration of the inner sleeve in the plug connector can specifically be prevented.

This is preferred especially if the inner sleeve is spaced radially from the second dielectric sub-body positioned in the connecting section. This measure can contribute to preventing an undesired deformation of the inner sleeve in the axial direction as can occur, in particular, during an axial loading of the connecting section and that instead, when such loading occurs, the contact surface between the connecting section of the sleeve or stated more precisely, its inner surface and the contact area of the inner sleeve shifts to the connecting section of the sleeve on the sleeve's inside surface.

In order to ensure this, in a preferred type of implementation, the second dielectric sub-body positioned in the connecting section is executed in steps so that the diameter decreases in the direction toward the first dielectric sub-body. However, this distance should be kept as low as possible.

This reaction to a load in the axial direction will be further supported if the inner sleeve is shaped in such a way that the contact area of the inner sleeve to the connecting section of the sleeve, across which the electrical contact is produced projects in the radial direction. This can be achieved especially by shaping it as a segment of a circle.

At the same time, it is especially preferred if the inner sleeve is mechanically preloaded in such a way that at the contact point or on the contact surface between inner sleeve and support section, surface pressure on the inner surface of the connecting section works to also ensure a good and intimate electrical contact between inner sleeve in this area during deformation of the balance section.

Particularly preferred in addition is, if a second inner sleeve is available, that it extend into a contact zone of the connecting section of the sleeve in which the electrical connection to the associated mating connector is produced.

This makes it possible, in particular, that the contact zone of the connecting section expands in the direction of the plug end of the sleeve into a funnel shape which can be there, if desired, in order to ensure good electrical contact to the mating connector, one of whose outside conductors is overlapping the sleeve as socket and nonetheless substantially avoid a negative influence on the HF signal.

Especially preferred in the use of inner sleeves that are elastically deformable, i.e. boast high elasticity as is the case, for example, with spring materials.

According to an embodiment of the present disclosure, at least two slots are positioned in the peripheral direction of the sleeve, one behind the other whereby preferably in the axial direction, the flexure section is equipped with at least two slots that are positioned offset from one another. That way, a sufficient bending radius can be achieved with which an offset can be balanced with values customary in production.

According to a preferred embodiment of the present disclosure, the connecting bridge is designed with an axial length corresponding to the width of the slot. Such a slot boasts an axial width such that the facing front sides of the support section and the balance section are spaced and therefore the connecting bridge also boasts an axial length corresponding to the axial width of the slot, as a result of which the necessary bending elasticity in the area of the flexure section can be ascertained.

A further advantageous embodiment of the present disclosure sees to it that the inside conductor boasts a reduction in diameter in the transition zone of the first dielectric sub-body and the second dielectric sub-body. As a result, the necessary bending elasticity will also be afforded to the inside conductor in the area of the flexure section of the sleeve.

A further improvement of the bending elasticity in the area of the flexure section is assured by the fact that the diameter of the inside conductor in the area of the second dielectric sub-body is designed with a smaller diameter compared to the diameter of the internal hole of the second dielectric sub-body.

In order to ascertain the dielectric properties of the dielectric of the connector in accordance with the disclosure, according to a further design of the disclosure, one of the neighboring front surfaces of the first and second dielectric sub-bodies boasts a blind borehole and the other front surface boasts a contour adapted to it that has, however, a smaller diameter than the blind borehole in order to make an axial offset and/or a tipping of the second dielectric sub-body relative to the first dielectric sub-body possible.

A further improvement of the bending elasticity in the area of the flexure section will be achieved, subject to further development, so that the connecting bridge boasts a bead directed toward the inside and running in the circumferential direction.

With such a bead on the connecting bridge, the second dielectric sub-body will be equipped with a groove running in the axial direction that runs congruently with the connecting bridge in order to receive this bead and therefore is implemented to a depth that is at least the height of the bead on the inner wall of the sleeve. Preferably, the bead will be designed as a triangular bead. Thereby with this beaded connecting bridge, a balancing of the length will be achieved by swinging the balance section with respect to the support section.

According to a further embodiment of the present disclosure, the support section of the sleeve is to be equipped with a connecting flange for mechanical and electrical connection at one of the front sides facing the flexure section. Thereby, the sleeve of the connector according to the disclosure can be deployed as an SMD component.

When it comes to further design improvements, it is foreseen that the balance section of the sleeve be equipped with a face plate lying across from the flexure section with a contact zone for electrical contact with a mating connector. In doing so, the contact zone of the balance section will preferably boast a circumferential bead whose bead base is designed to create contact with an outside conductor of a mating connector.

Preferably, the second dielectric sub-body is designed to be shorter than the axial length of the contact zone, in other words positioned outside the contact zone, so that the sleeve in the area of the contact zone can accept as socket the contact zone as a mating connector.

Such an electric connector arrangement with an electrical connector in accordance with the disclosure and a mating connector is distinguished, in accordance with the disclosure, in that the mating connector includes:
a. an outside conductor designed as sleeve with a contact zone for contacting the outside conductor of the electrical connector and a connecting flange for mechanical electrical connection to a circuit board,
b. an inside conductor with a blind borehole to receive the inside conductor of the electrical connector,
c. a dielectric designed as a cylindrical dielectric body with an internal hole to receive the inside conductor.

Such an electric connector arrangement is suitable for use as a B2B electrical connection to connect two parallel positioned circuit boards for which a lateral offset between the electrical connector and the associated mating connector is compensated by means of the flexure section electrical connector according to the disclosure.

### BRIEF DESCRIPTION OF DRAWINGS

The present disclosure will next be described in detail on the basis of application examples with reference to the enclosed figures. These show:

FIG. 1: an external view of one of the first implementation examples of the electrical connector in accordance with the disclosure,

FIG. 2: a sectional view along the axis of the electrical connector shown in FIG. 1,

FIG. 3: a sectional view along the axis of a mating connector to the electrical connector shown in FIGS. 1 and 2, and

FIG. 4: a sectional view along the axis of an electrical connector arrangement according to the disclosure consisting of an electrical connector in accordance with FIGS. 1 and 2 and a mating connector in accordance with FIG. 3.

### DETAILED DESCRIPTION

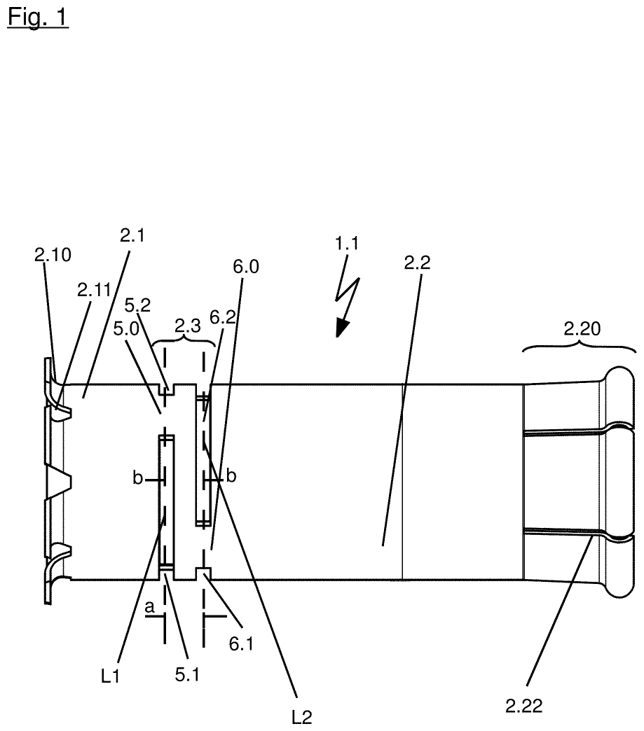

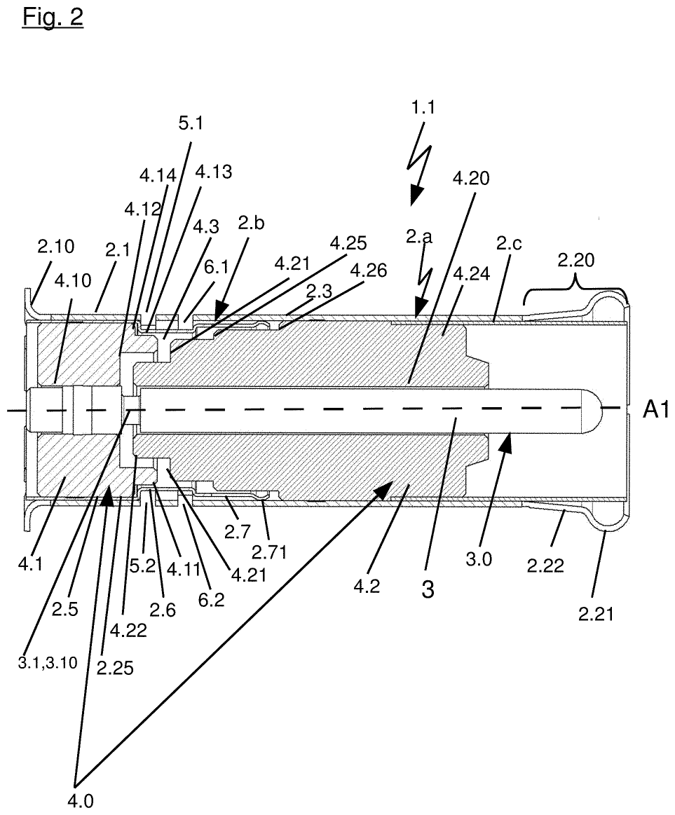

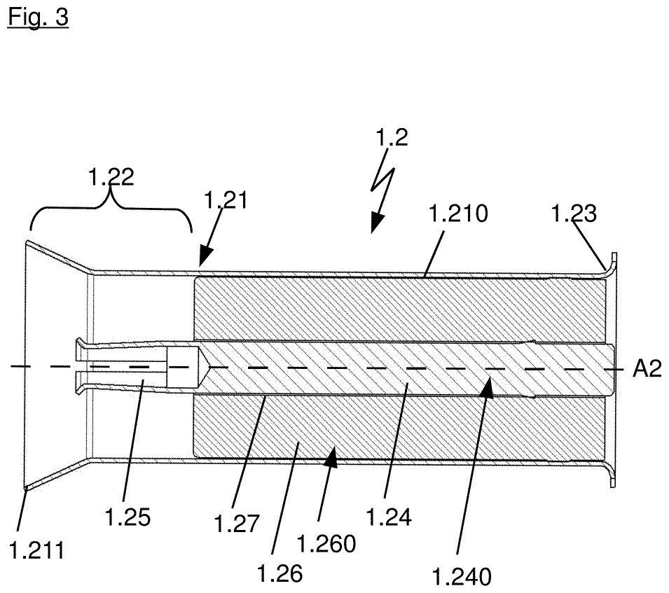

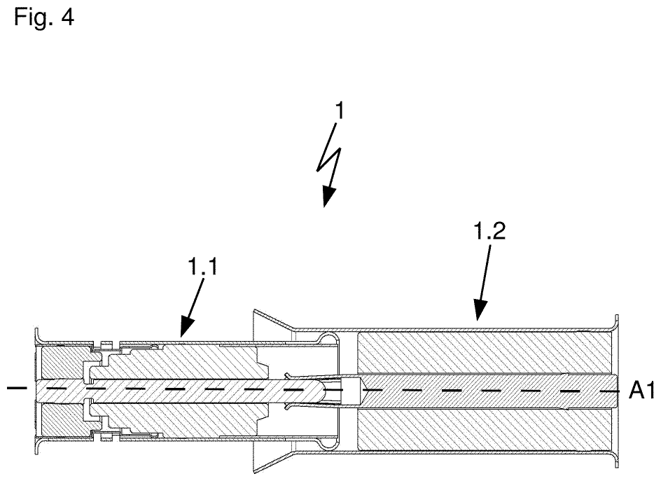

FIGS. 1 and 2 show an electrical connector 1.1 which, together with an associated mating connector 1.2 as shown in FIG. 3, show a connector arrangement 1 as B2B connector that electrically connects two circuit boards (not shown), as in FIG. 4. For this purpose, in accordance with FIG. 4, the electrical connector 1.1 is connected mechanically and electrically by means of a connecting flange 2.10 with the one circuit board and the mating connector 1.2 via a connecting flange 1.23 electrically and mechanically with the other circuit board.

This electrical connector arrangement 1 boasts the property that for a lateral or angular offset, the electrical connectors 1.1 and 1.2 that are mechanically connected to the circuit boards with respect to their axes of symmetry, a tolerance compensation of this offset by means of the electrical connectors 1.1 becomes possible. If for example, the electrical connector arrangement 1 shown in FIG. 4 is exposed to an angular offset as can occur, for example, if the circuit boards are not oriented completely parallel to one another, it will result in a tipping of the two connectors 1.1 and 1.2 toward each other. This tipping will be compensated by means of a flexure section 2.3 or a bending zone of the electrical connector 2.1 of the connector arrangement 1. This balancing or tolerance function of the electrical connector 1.1, which also works for a parallel offset of the circuit boards by permitting the axes of symmetry of the connectors 1.1 and 1.2 on which they are positioned to align with one another will be explained below.

In accordance with FIGS. 1 and 2, the electrical connector 1.1 incorporates one inner sleeve positioned in sleeve 2a and two inside the sleeve 2a, identified as 2b and 2c that extend in each case in the axial direction across a section of the sleeve 2a, existing outside conductor 2.0, an inside conductor pin 3 as inside conductor 3.0 as well as a dielectric 4.0 which fills most of the space remaining between the inside conductor 3.0 and the outside conductor 2.0 which essentially consists of cylindrically shaped dielectric body 4, made up of two parts, a first dielectric sub-body 4.1 and a second dielectric sub-body 4.2.

The sleeve 2a of the electrical connector 1.1 consists of three axial sections, namely an axial support section 2.1 and an axial balance section 2.2 which are mechanically connected across the aforementioned axial flexure section 2.3. On the free front face of the support section 2.1, a connecting flange 2.10 has been preformed while the border area of this front face is widened toward the outside in a funnel shape and thereby a contact surface has arisen for the contact with a circuit board and for mechanical connection to the same. In addition, this connecting flange 2.10 is provided with radial slots 2.11.

On the facing, plug front face of the sleeve 2a, the balance section 2.2 ends in a contact zone 2.20 for contacting the outside conductor 2.0 electrically or the inside conductor 3.0 with an outside conductor 1.210 or an inside conductor 1.240 of the mating conductor 1.2 (cf. FIG. 4).

In so doing, an inner sleeve 2c is positioned in the end portion on the plug side as an additional component of the outside conductor 2.0; this sleeve is held between the plug-side end portion 4.24 of the second dielectric sub-body 4.2 and the inner side of a section of the balance section 2.2 of the sleeve 2a and extends up to its plug-side end in essentially equal radial separation from the center axis of the electrical connector 1.1.

In the area of the flexure section 2.3, two neighboring perimeters L1 and L2 run in the axial direction. As is already suggested by the term, “perimeters”, the axial coordinate of all points on a given perimeter is always the same; the perimeters L1 and L2 thus lie in each case on an undisplayed level, to which the axial direction is perpendicular.

Two slots 5.1 and 5.2 are positioned on the perimeter L1, between which in each case, unslotted areas lie on the perimeter L1 and in each case form a ring-segment type of connecting bridge 5.0. On the other perimeter L2 are likewise found two slots 6.1 and 6.2 with the unslotted area between these two slots 6.1 and 6.2 providing a further connecting bridge 6.0 of the ring-segment type. The slots 6.1 and 6.2 lying on the perimeter L2 are positioned offset with respect to the slots 5.1 and 5.2 lying on the perimeter L1 in such a way that the connecting bridges 5.0 and 6.0 do not align axially with one another.

The separation a of the two perimeters L1 and L2 is small compared to the axial length L of the electrical connector 1.1. The slots 5.1, 5.2, 6.1 and 6.2 boast a width b that can, for example, amount to 1 mm (0.04 in). The axial length of the connecting bridges 5.0 and 6.0 therefore correspond to the width of the slots 5.1, 5.2, 6.1 and 6.2. The neighboring position of the two perimeters L1 and L2 leads to a formation of a ring-shaped area 7 between slots 5.1 and 5.2 on the perimeter L1 and the slots 6.1 and 6.2 on the perimeter L2. The two segments of sleeve 2, the support section 2.1 and the balance section 2.2 are connected across this ring-shaped area 7 as well as, on the one hand, across the connecting bridge 5.0 and on the other hand, across the connecting bridge 6.0.

With such a flexure section 2.3 of the sleeve 2a, an articulated property is achieved so that the balance section 2.2 can be angled with respect to the support section 2.1. But the slots 5.1, 5.2, 6.1 and 6.2 in the sleeve 2a can lead to a negative influence on the signal quality, especially for HF signals that has to be compensated or at least, limited.

Toward this end, an inner sleeve 2b is provided for this as an additional component of the outside conductor 2.0; it is positioned inside sleeve 2a. The inner sleeve 2b, which is elastic, boasts a support section 2.5 positioned in the support section 2.1 of the sleeve 2a which stands in electrical contact with the inside surface of the support segment 2.1 of sleeve 2a and is preferably attached to this inside surface and/or to the first dielectric sub-body 4.1.

In addition, the inner sleeve 2b boasts a radially back-springing section 2.6 that is connected to the support section 2.5 in the direction of the plug and covers the flexure section 2.3 of the sleeve 2a from inside and a connecting section 2.7 that is connected to the radially back-springing section 2.6 that runs inside the balance section 2.2 of the sleeve 2a.

Stated more precisely, the connecting section 2.7, as it is shown for example in FIG. 2, preferably at a small separation that amounts, for example, to about 1 mm or even less than 1 mm, runs to the second dielectric sub-body 4.2. In addition, the electrical contact to the balance section 2.2 of the sleeve 2a is produced through a contact section 2.71 of the connecting section 2.7 which protrudes in the radial direction so that an electrical contact to the inside of the balance section 2.2 of the sleeve 2a is produced that is especially good if at least the connecting section 2.7 of the inner sleeve 2a is preloaded mechanically to such an extent that the contact section 2.71 is pressed against the inside of the balance section 2.2 of the sleeve 2a. By so doing, the contact section 2.71 is however not tightly connected to the inside of the balance section 2.2 of the sleeve 2a so that the contact point or contact line can shift.

In addition, the elastic bending property must also be ascertained for both the dielectric 4.0 and the inside conductor 3.0.

The appropriate bending elasticity for the dielectric 4.0 is reached by having the dielectric body 4 produced in two parts: the first dielectric sub-body 4.1 positioned in the support section 2.1 and a second dielectric sub-body 4.2 positioned in the balance section 2.2.

These two dielectric sub-bodies 4.1 and 4.2 are positioned in sleeve 2 with a gap 4.3 formed between their two neighboring front faces 4.11 and 4.21 whereby gap 4.3 aligns with the ring-shaped area 7 of the flexure section 2.3, originating from the circumferential surface of the two dielectric sub-bodies 4.1 and 4.2.

The two front faces 4.11 and 4.21 of the two dielectric sub-bodies 4.1 and 4.2 are designed with contours adapted to one another. The front face 4.11 of the first dielectric sub-body 4.1 protrudes into the flexure section 2.3.

Accordingly, the first dielectric sub-body 4.1 boasts a section 4.13 in which its expansion in the radial direction is reduced by a step 4.14 in order to receive the radially back-springing section 2.6 of the inner sleeve 2b and to be able to support it in the axial direction.

In addition, the first dielectric sub-body body 4.1 boasts a central blind borehole 4.12 to which the front face 4.21 with a cylindrically shaped extension 4.22 that dips into the blind borehole 4.12 is adapted. The diameter of the extension 4.22 is smaller than the diameter of the blind borehole 4.12, so that the gap 4.3 extending from the peripheral surface of the two dielectric sub-bodies 4.1 and 4.2 continues across a radial separation between the extension 4.22 and the circumferential surface of the blind borehole 4.12 as in a labyrinth up to the inside conductor 3.0.

The diameter of the second dielectric sub-body 4.2 is extended starting with the extension 4.22 stepwise across a first step 4.25 and a second step 4.26 up to the full inside diameter of the sleeve 2a. The first step 4.25 of the second dielectric sub-body 4.2 is thereby designed with regard to its diameter and its axial extension in such a way that it itself does not come into contact with the back-springing section 2.6 of the inner sleeve during maximum deformation of the flexure section 2.3 of the sleeve 2b. The second step 4.26 of the second dielectric sub-body 4.2 is designed in such a way that it does not come into contact in the axial direction with the contact section 2.71 of the inner sleeve 2b during maximum axial deformation of the flexure section 2.3 of the sleeve 2a.

The inside conductor 3.0 will be stored as inside conductor pin 3 in an internal hole 4.10 of the support section 2.1 and an internal hole 4.20 of the balance section 2.2 whereby in the area of the base of the groove of the blind borehole 4.12 on the front face 4.11 of the support section 2.1 of the inside conductor pin 3 boasts a tapering of the diameter 3.1 in the form of a circumferential groove 3.10 with a rectangular cross-section whereby this groove 3.10 extends into the extension 4.22. While the groove 3.10 runs in the direction of the area following the balance section 2.2, the inside conductor pin 3 boasts a diameter d that is slightly smaller than the diameter of the blind borehole 4.20 of the second dielectric sub-body 4.2.

With an inside conductor pin 3 designed in that fashion, together with the two-part dielectric body 4 and the flexure section 2.3 of the sleeve 2, the bending elasticity of the connector 1.1 needed for a compensation of a lateral offset with regard to the axes of symmetry A1 and A2 of the electrical connector 1.1 and the mating connector 1.2 is achieved.

The mating connector 1.2 used for the connector arrangement 1 in accordance with FIG. 4 is shown in FIG. 3 and includes a sleeve 1.21 as outside conductor 1.210 in which an inside conductor pin 1.24 as inside conductor 1.240 and a cylindrically shaped dielectric body 1.26 as dielectric 1.260 are positioned.

The mating connector 1.2 boasts a contact zone 1.22 at one end into which the sleeve 1.21 extends whereby the plug end 1.211 of the sleeve 1.21 expands in the manner of a funnel.

At the other end of the mating connector 1.2, a connecting flange 1.23 from the sleeve 1.21 is flared as a result of which the border area of the sleeve 1.21 assumes the shape of a funnel that serves as a contact surface for contact with the circuit board 11 as well as for mechanical connection with the same. In addition, this connecting flange 1.23 is provided with radial slots 1.230.

Between this connecting flange 1.23 and the contact zone 1.22 may be found the dielectric body 1.26 with an internal hole 1.27 for receiving the inside conductor pin 1.24. This inner conductor pin 1.24 boasts at its end that projects into the contact zone 1.22 a slotted and funnel-shaped expanded blind borehole 1.25 for receiving the inside conductor pin 3 of the electrical connector 1.1.

The electrical connector 1.1 in accordance with FIGS. 1 and 2 can also be configured with more than two slots 5.1 and 5.2 on one perimeter L1. In addition, it is also possible, instead of two perimeters L1 and L2 provided next to one another in the axial direction, to provide only one perimeter L1 or more than two perimeters.

The connection between the electrical connector 1.1 and the mating connector 1.2 takes place as shown in FIG. 4 across the contact zone 2.20 of the connector 1.1 that is designed as the plug and the contact zone 1.22 of the mating connector 1.2 designed as the socket.

The contact zone 2.20 of the balance section 2.2 of the sleeve 2 of the mating connector 1.1 boasts a bead 2.21 running in the peripheral direction and pointing outwards with which the front face of the balance section 2.2 is widened. To achieve a characteristic of resiliency, axially running slots 2.22 are provided in this contact zone 2.20. The second dielectric sub-body 4.2 ends before this contact zone 2.20, whereby the inside conductor pin 3 projects into this contact zone 2.20.

To connect the electrical connector 1.1 with the mating connector 1.2 electrically, the contact section 1.22 of the mating connector 1.2 is slid onto the plug formed by the contact zone 2.20 of the sleeve 2, so that the base of the groove touches the bead 2.21 at the peripheral surface of the contact zone 1.22 of the sleeve 1.21 while making electrical contact and at the same time the end of the inside conductor pin 3 of the electrical connector 1.1 is inserted into the blind borehole 1.25 of the inside conductor pin 1.24 of the mating connector 1.2 while forming an electrical contact, as can be seen in FIG. 4.

### REFERENCE NUMBER LIST

1 Electrical connector arrangement
1.1 Electrical connector
1.2 Mating connector for the electrical connector 1.1
1.21 Sleeve of the mating connector 1.2
1.210 Outside conductor of the mating connector 1.2
1.211 Plug end of the sleeve 1.21
1.22 Contact zone of the sleeve 1.21
1.23 Connecting flange of the sleeve 1.21
1.230 Radial slots of the connecting flange 1.23
1.24 Inside conductor pin
1.240 Inside conductor
1.25 Blind borehole
1.26 Dielectric body
1.260 Dielectric
1.27 Internal hole of the dielectric body 1.26
2a Sleeve of the electric connector 1.1
2b Inner sleeve of the electrical connector 1.1
2c Inner sleeve of the electrical connector 1.1
2.0 Outside conductor
2.1 Support section of the sleeve 2a
2.10 Connecting flange of the support section 2.1
2.11 Radial slot of the connecting flange 2.10
2.2 Balance section of the sleeve 2a
2.20 Contact zone of the balance section 2.2
2.21 Bead of the contact zone 2.20
2.22 Axial slot of the contact zone 2.20
2.23 Base of the groove base of the bead 2.21
2.3 Flexure section of the sleeve 2a
2.4 Inner wall of the sleeve 2a
2.5 Support section of the inner sleeve 2b
2.6 Radially back-springing section of the inner sleeve 2b
2.7 Connecting section of the inner sleeve 2b
2.71 Contact section of the connecting section 2.7
3 Inside conductor pin
3.0 Inside conductor
3.1 Tapering of the cross-section
3.10 Groove of the inside conductor pin 3
4 Dielectric body
4.0 Dielectric
4.1 First dielectric sub-body
4.10 Internal hole of the first dielectric sub-body 4.1
4.11 Front face of the first dielectric sub-body 4.1
4.12 Blind borehole on the front face 4.11
4.13 Section of the first dielectric sub-body 4.1
4.14 Step in the first dielectric sub-body 4.1
4.2 Second dielectric sub-body
4.20 Internal hole of the second dielectric sub-body 4.2
4.21 Front face of the second dielectric sub-body 4.2
4.22 Cylindrically shaped extension of the second dielectric sub-body 4.2
4.23 Groove of the second dielectric sub-body 4.2
4.24 Plug-side end portion of the second dielectric sub-body 4.2
4.25 First step of the second dielectric sub-body 4.2
4.26 Second step of the second dielectric sub-body 4.2
4.3 Gap
5.0 Connecting bridge
5.1 Slot
5.2 Slot
5.3 Slot
6.0 Connecting bridge
6.1 Slot
6.2 Slot
7 Ring-shaped area of the flexure section 2.3
L1 Perimeter of the sleeve 2a
L2 Perimeter of the sleeve 2a

1. An electrical connector comprising:
an outside conductor that comprises an outer sleeve and an inner sleeve that is positioned within the outer sleeve and extends axially across part of the outer sleeve,
an inside conductor,
a dielectric formed as a cylindrically shaped dielectric body with an internal hole to accommodate the inside conductor,
wherein the outer sleeve is formed with one axial support section and one axial balance section, which are connected by an axial flexure section,
wherein the axial flexure section comprises a slot running along a perimeter of the outer sleeve,
wherein an unslotted area is the axial support section with a connecting bridge connecting with the axial balance section, and
wherein the dielectric body comprises a first dielectric sub-body arranged in the axial support section and a second dielectric sub-body positioned in the axial balance section,
wherein the first and the second dielectric sub-bodies are arranged separately from one another in the outer sleeve.

2. The electrical connector in accordance with claim 1, wherein the inner sleeve extends across the axial flexure section.

3. The electrical connector in accordance with claim 2, wherein the inner sleeve springs back radially in the axial flexure section.

4. The electrical connector in accordance with claim 2, wherein the inner sleeve is mechanically connected tightly and in electrically conductive fashion to the axial support section and is connected to the connecting section with an electrical contact such that a contact point or contact surface is movable between the inner sleeve and the axial support section on an inner surface of the connecting section.

5. The electrical connector in accordance with claim 2, wherein the inner sleeve is supported on the first dielectric sub-body positioned in the axial support section and/or is connected to the first dielectric body positioned in the axial support section.

6. The electrical connector in accordance with claim 2, wherein the inner sleeve is radially separated from the second dielectric sub-body positioned in the connecting section.

7. The electrical connector in accordance with claim 4, wherein the inner sleeve is mechanically preloaded so that at the contact point or on the contact surface between inner sleeve and the connecting section, contact pressure on the inner surface of the connecting section has an effect.

8. The electrical connector in accordance with claim 1, wherein a second inner sleeve is available that extends into a contact zone of the connecting section.

9. The electrical connector in accordance with claim 8, wherein the contact zone of the connecting section widens into a funnel shape.

10. The electrical connector in accordance with claim 1, wherein the inner sleeve is elastically deformable.

11. The electrical connector in accordance with claim 1, wherein at least two slots are positioned, one behind the other on a perimeter of the sleeve.

12. The electrical connector in accordance with claim 1, wherein the flexure section is equipped in an axial direction with at least two slots, that are arranged offset one from the other.

13. The electrical connector in accordance with claim 1, wherein the connecting bridge is designed with an axial length corresponding to a width of the slot.

14. The electrical connector in accordance with claim 1, wherein the inside conductor comprises a tapering of its profile in the transition zone of the first dielectric sub-body and the second dielectric sub-body.

15. The electrical connector in accordance with claim 1, wherein a diameter of the inside conductor in an area of the second dielectric sub-body is equipped with a smaller diameter in comparison with a diameter of the internal hole of the second dielectric sub-body.

16. The electrical connector in accordance with claim 1, wherein neighboring front faces of the first and second dielectric sub-bodies comprise a blind borehole and a other front surface comprises a contour adapted to the blind borehole that however has a smaller diameter than the blind borehole.

17. The electrical connector in accordance with claim 8, wherein the second dielectric sub-body is positioned outside the contact zone in the connecting section.

18. The electrical connector in accordance with claim 1, further comprising:
a mating connector, wherein the mating connector comprises:
an outside conductor configured as a sleeve with a contact zone for contacting the outside conductor of the connector and a connecting flange for mechanical and electrical connection to a circuit board,
an inside conductor with a blind borehole for receiving the inside conductor of the electrical connector,
a dielectric configured as a cylindrical dielectric body with an internal hole for receiving the inside conductor.

19. Use of the electrical conductor arrangement in accordance with claim 18 for the electrical connection of two circuit boards.
